(19) United States
(12) Patent Application Publication
(10) Pub. No.: US 2011/0047307 A1
(43) Pub. Date: Feb. 24, 2011

(54) DATA TRANSFER METHOD AND DATA TRANSFER APPARATUS

(75) Inventor: Yasuyuki KUBOTA, Kasugai (JP)

Correspondence Address: Fujitsu Patent Center;Fujitsu Management Services of America, Inc., 2318 Mill Road, Suite 1010, Alexandria, VA, 22314, US

(73) Assignee: FUJITSU SEMICONDUCTOR LIMITED, Yokohama-shi (JP)

(21) Appl. No.: 12/861,823

(22) Filed: Aug. 23, 2010

(30) Foreign Application Priority Data
Aug. 24, 2009 (JP) 2009-193499

(51) Int. Cl. G06F 13/38

(52) U.S. Cl. 710/104

(57) ABSTRACT

A data transfer method for transferring data between a source device and a sink device includes receiving a query about a channel number included in connection plug information from the sink device and notifying the sink device of information of an unused connection plug when a channel corresponding to the channel number is unused.

### CROSS-REFERENCE TO RELATED APPLICATIONS

This application claims the benefit of priority from Japanese Patent Application No. 2009-193499 filed on Aug. 24, 2009, the entire contents of which are incorporated herein by reference.

### BACKGROUND

1. Field

Embodiments discussed herein relate to data transfer technology.

2. Description of Related Art

The Institute of Electrical and Electronics Engineers (IEEE) 1394 interface standard (hereinafter, “1394 standard”) is a serial interface that coupled between nodes such as a personal computer and a digital video camera. The IEEE 1394 standard includes an isochronous transfer mode in which audio data and image data are transferred in real time and an asynchronous mode in which still image data and control commands are transferred.

Related art is disclosed in, for example, Japanese Laid-open Patent Publication No. 2005-347953 or Japanese Laid-open Patent Publication No. 2001-045030.

### SUMMARY

According to one aspect of the embodiments, a data transfer method of transferring data between a source device and a sink device includes receiving a query about a channel number included in connection plug information from the sink device and notifying the sink device of information of an unused connection plug when a channel corresponding to the channel number is unused.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an exemplary plug register;

FIG. 2 illustrates an exemplary output plug control register;

FIG. 3 illustrates an exemplary input plug control register;

FIGS. 4A to 4C illustrate exemplary point-to-point (PtoP) connections;

FIG. 5 illustrates an exemplary connection process;

FIG. 6 illustrates an exemplary serial bus block write packet;

FIG. 7 illustrates an exemplary AV/C command frame;

FIG. 8A illustrates an exemplary request format;

FIG. 8B illustrates an exemplary response format;

FIG. 9 illustrates an exemplary topology;

FIG. 10 illustrates an exemplary IEEE 1394 protocol controller;

FIG. 11 illustrates an exemplary request format;

FIGS. 12A and 12B illustrate exemplary response formats;

FIG. 13 illustrates an exemplary plug connection;

FIG. 14 illustrates an exemplary establishment of a plug connection;

FIG. 15 illustrates an exemplary establishment of a plug connection; and

FIG. 16 illustrates an exemplary establishment of a plug connection.

### DESCRIPTION OF EMBODIMENTS

In isochronous (Iso) transfer, an isochronous channel number (channel number) and a bandwidth obtained from an isochronous resource manager (IRM) are used, and Iso data is transferred between devices between which a plug connection has been established. Data (packet) is identified using the channel number. The channel number and the bandwidth are obtained by rewriting public registers in the IRM.

Establishment of a plug connection includes a point-to-point connection (PtoP connection) that couples an output plug of a device to an input plug of another device, and a broadcast connection that couples an output plug or an input plug to an isochronous channel. A plug register provided in a device is used to establish a plug connection. The plug register is defined in the International Electrotechnical Commission (IEC) 61883 standard and includes a master plug register (MPR) and a plug control register (PCR).

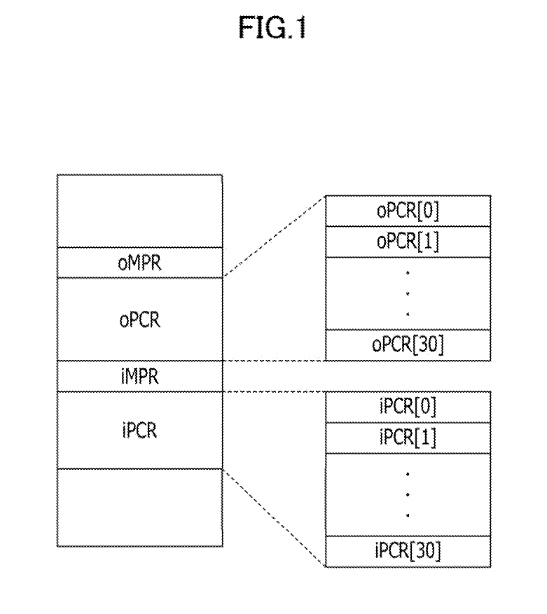

FIG. 1 illustrates an exemplary plug register. The master plug register (MPR) includes an input master plug register (iMPR) and an output master plug register (oMPR).

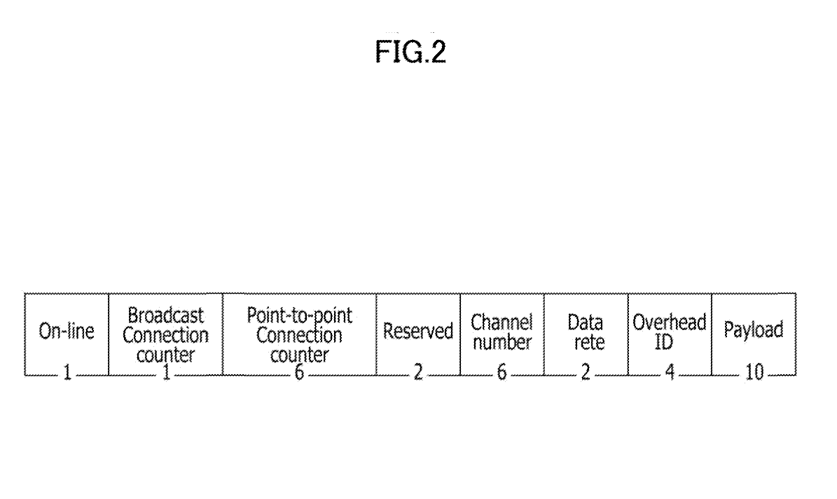

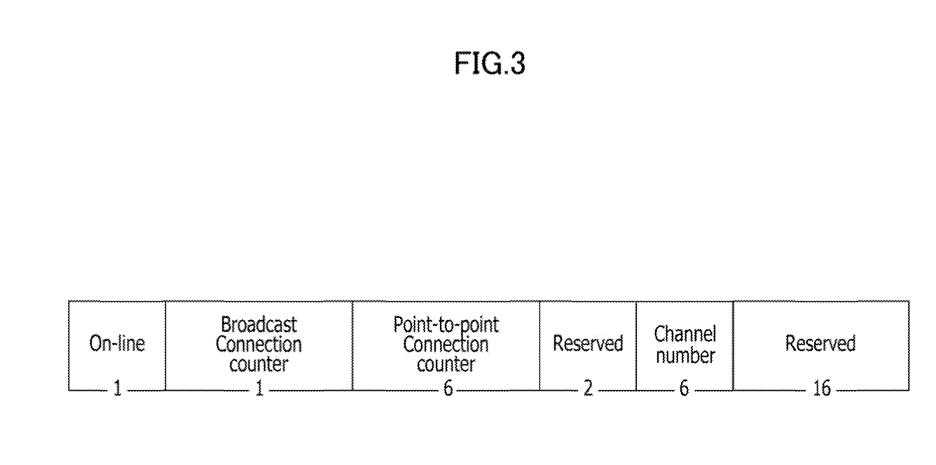

The plug control register (PCR) includes an input plug control register (iPCR) for controlling attributes of an input plug (connection plug) and an output plug control register (oPCR) for controlling attributes of an output plug (connection plug). FIG. 2 illustrates an exemplary output plug control register. FIG. 3 illustrates an exemplary input plug control register. Numerals indicated in FIGS. 2 and 3 each denote the number of bits of data.

As illustrated in FIG. 2, the output plug control register (oPCR) includes eight regions. An “on-line” region indicates a usage status of the output plug. For example, the output plug is in an online state where Iso data may be sent when “1” is set in the on-line region is 1. The output plug is in an offline state where Iso data may not be sent when “0” is set in the on-line region. A “point-to-point connection counter” (“pcc”) region indicates the number of PtoP connections formed via the output plug. A “channel number” (“ch”) region indicates an isochronous channel number (channel number) to which the output plug is coupled.

As illustrated in FIG. 3, the input plug control register (iPCR) includes six regions. An “on-line” region indicates whether the input plug is in an online state (=1) where Iso data may be received or an offline state (=0) where Iso data may not be received. A “pcc” region indicates the number of PtoP connections formed via the input plug. A “ch” region indicates a channel number to which the input plug is coupled.

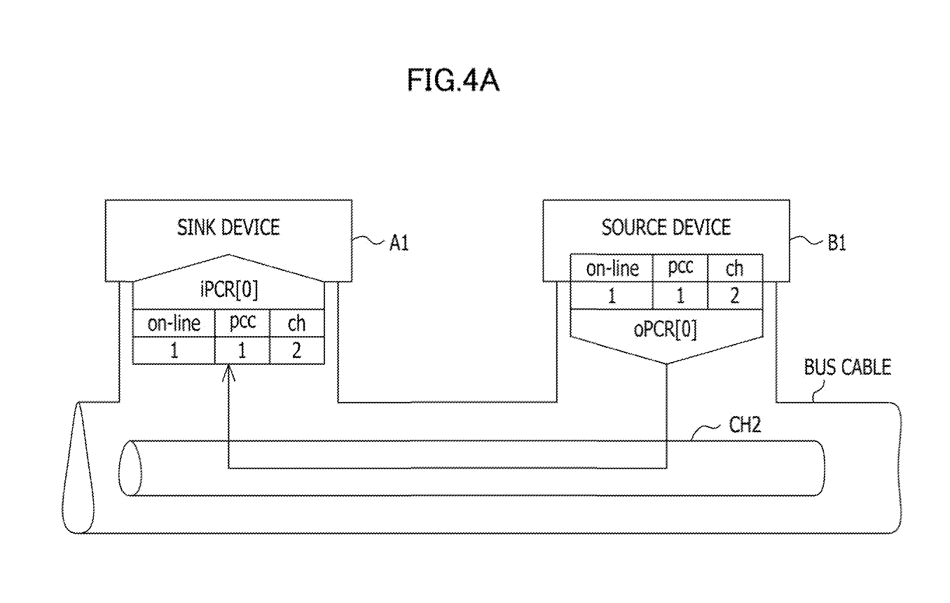

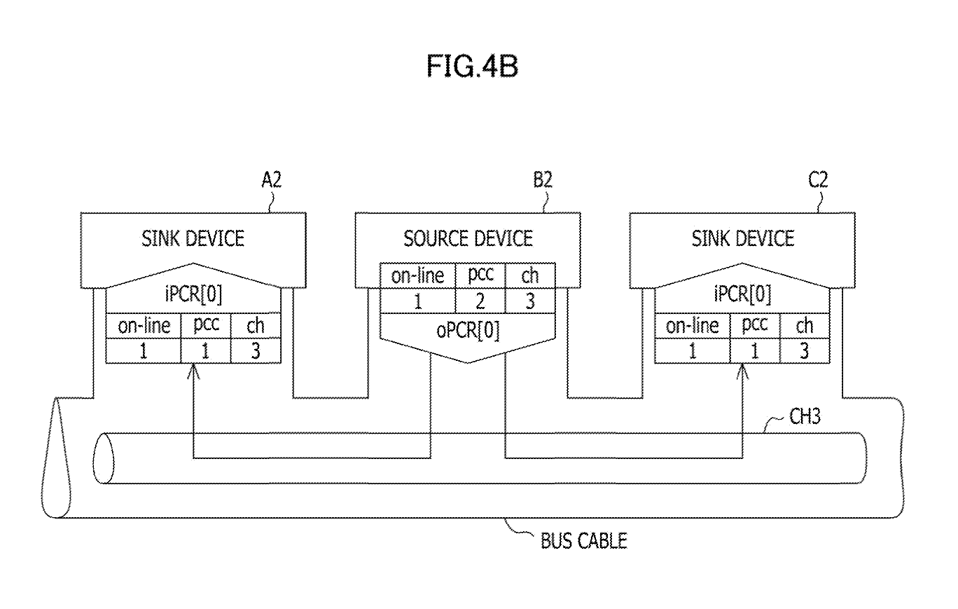

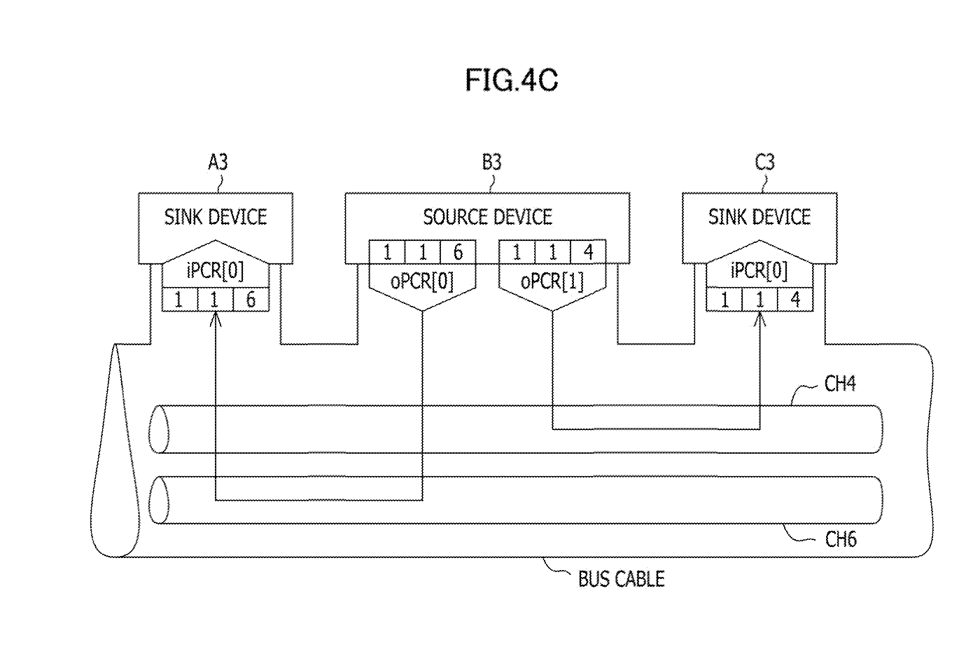

FIGS. 4A to 4C illustrate exemplary PtoP connections.

Referring to FIG. 4A, oPCR[0] of a source device B1 and iPCR[0] of a sink device A1 are coupled to a channel CH2. Register values of oPCR[0] of the source device B1 may be in a state where “on-line” is set to an online state, “pcc” is set to [1] because of one PtoP connection, and the channel number is set to [2]. Register values of iPCR[0] of the sink device A1 may be in a state where “on-line” is set to may be [1] that indicates an online state, “pcc” is set to [1], and the channel number is set to [2].

The channel number of oPCR of a source device may be uniquely determined. Referring to FIG. 4B, sink devices may share a channel number. For example, oPCR[0] of a source device B2 and iPCR[0] of a sink device A2 may be coupled to a channel CH3, and oPCR[0] of the source device B2 and iPCR[0] of a sink device C2 may overlay another PtoP connection using the channel CH3. Since the number of PtoP connections is two, “pcc” of oPCR[0] of the source device B2 may be [2].

Referring to FIG. 4C, a source device B3 includes a plurality of channels. oPCR[0] of the source device B3 and iPCR[0] of a sink device A3 are coupled to a channel CH6, and oPCR[1] of the source device B3 and iPCR[0] of a sink device C3 are coupled to a channel CH4. “ch” of oPCR[0] of the source device B3 may be [4], and “ch” of oPCR[1] of the source device B3 may be [6].

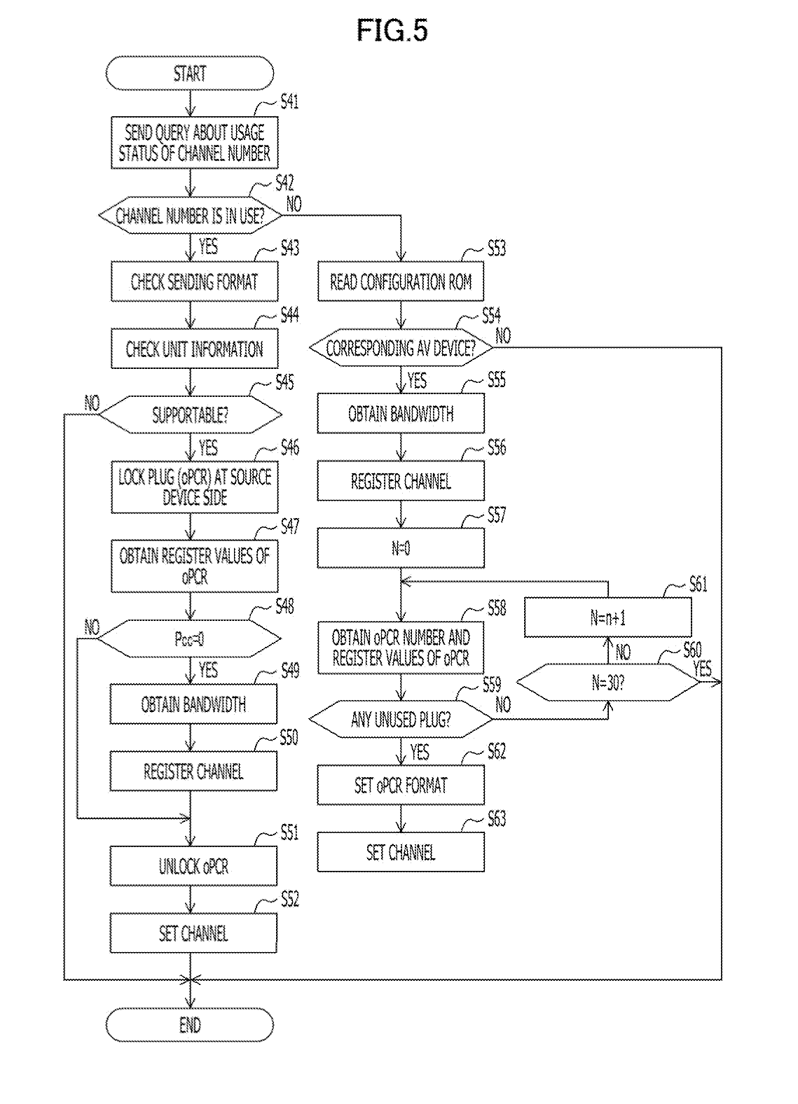

FIG. 5 illustrates an exemplary connection process. In operation S41, after a bus reset, e.g., when power is turned on, a sink device queries all source devices as to the usage status of an isochronous channel number by using a channel usage status command, which is an AV/C connection command. Each of the source devices sends, to the sink device, a response packet indicating whether the source device is using the channel number. In operation S42, the sink device determines whether the channel number is used or not, based on the response packet from each of the source devices.

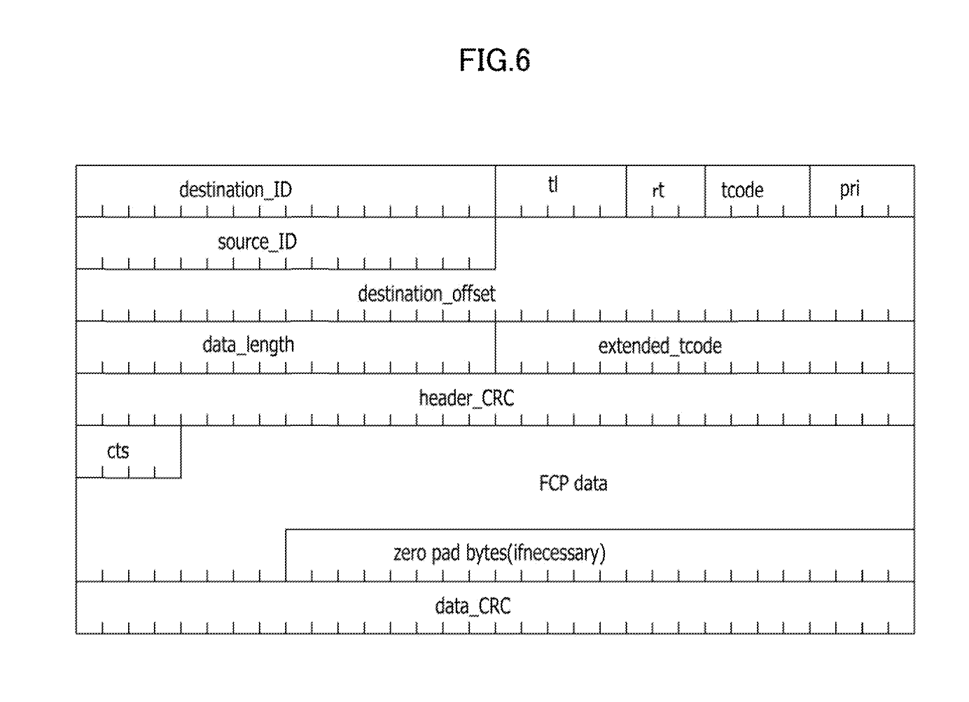

Referring to FIG. 6, an AV/C command frame included in a Function Control Protocol (FCP) frame, which is a lower protocol of AV/C, is transferred as a serial bus block write packet illustrated in FIG. 6.

FIG. 6 illustrates an exemplary serial bus block write packet. The serial bus block write packet includes a packet header, a header CRC (header_CRC), an FCP frame, and a data CRC (data_CRC). The packet header includes information such as a destination_ID indicating the node ID of a data transfer destination, a transaction label (tl) indicating a packet number, or a retry code (rt) indicating whether this packet is a packet transferred for the first time. The packet header includes information such as a tcode indicating a command code, a priority (pri) indicating the priority of the packet, a source_ID indicating the node ID of a data transfer source, a destination_offset, a data_length indicating the data size of FCP data, or an extended_tcode. The header CRC includes an error detecting code for the packet header. The data CRC includes an error detecting code for the FCP data.

A Command and Transaction Set (cts) is described in the most significant four bits in the head of the AV/C command frame included in the FCP frame. “cts” indicates the ID of a command set of the write packet. The write packet may be an AV/C command packet when “cts” is [0000].

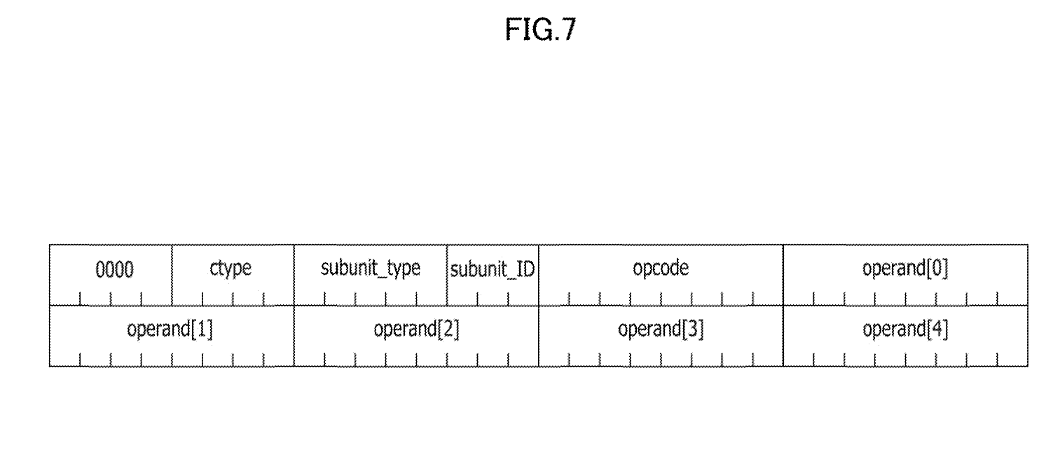

FIG. 7 illustrates an exemplary AV/C command frame. The AV/C command frame includes a command type (ctype) indicating the function category of a command, a subunit_type indicating the type of a subunit of a sending source device (a monitor or a video cassette recorder (VCR)), or a subunit_ID for specifying each subunit.

The AV/C command frame includes an operation code (opcode) and operands that are parameters for the operation code. The operation code includes a command for each subunit. In the AV/C Digital Interface Command Set General Specification, a channel usage status command [12h] (hexadecimal number) is defined as an AV/C connection command. The channel usage status command gives a query about the channel number setting status of a source device that performs Iso transfer, and the node ID of the source device or an oPCR number of oPCR in which the channel number is set is sent as a response.

Information for the command is set in the operands when the channel usage status command is set, for example, when [12h] is set as the opcode of the AV/C command frame. The channel number may be stored in operand 0, the node ID may be stored in operands 1 and 2, and the oPCR number may be stored in operand 3.

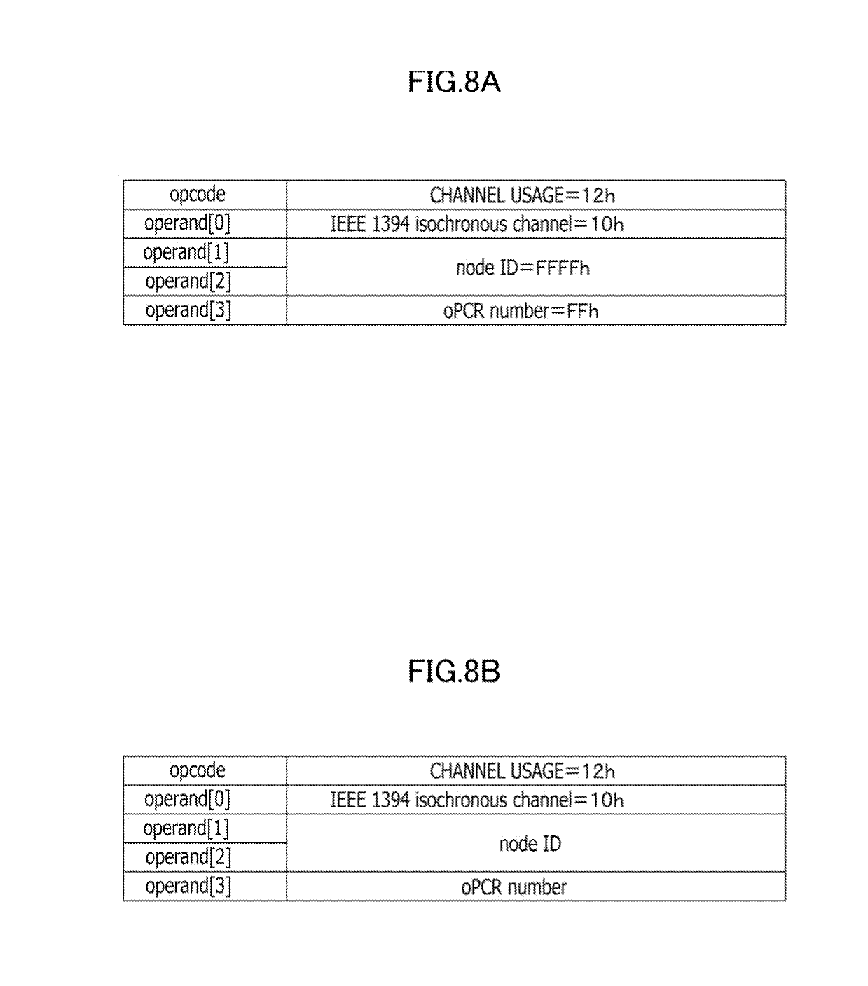

FIG. 8A illustrates an exemplary request format, and FIG. 8B illustrates an exemplary response format. In the request format, the channel number of a channel coupled to a sink device is stored in operand, [FFFFh] is stored in operands 1 and 2, and [FFh] is stored in operand 3. In operation S41 illustrated in FIG. 5, request data illustrated in FIG. 8A is sent from the sink device to each source device.

In the response format, a corresponding node ID is stored in operands 1 and 2 and the oPCR number is stored in operand 3 when the channel number which is inquired is used. [FFFFFFh] is stored in operands 1 to 3 when the channel number which is inquired by the sink device is not used.

In operation S42 illustrated in FIG. 5, the sink device receives response data having the format illustrated in FIG. 8B from the source device. Whether the channel number is used or not is determined based on information in operands 0 to 3.

When the source device is supported by the sink device (YES in operation S45), the plug (oPCR) at the source device side is locked in operation S46. oPCR with the channel number which is inquired is locked, and other sink devices may not change oPCR. In operation S47, for example, register values of the locked oPCR, which are illustrated in FIG. 2, are obtained. The sink device obtains or is notified of the node ID and the oPCR number from a write packet from the source device, and obtains or is notified of register values of oPCR from the source device by using a read request. When the register value “pcc” of oPCR, which is illustrated in FIG. 2, is [0] (YES in operation S48), the bandwidth for IRM is obtained in operation S49, and the channel number is registered in operation S50. In operation S51, oPCR is unlocked. In operation S51, the registered channel number is updated in the unlocked oPCR of the source device and iPCR of the sink device by using a lock transaction. A PtoP connection is established between oPCR of the source device and iPCR of the sink device, and oPCR of the source device transfers Iso data to iPCR of the sink device.

When “pcc” of oPCR is not [0] in operation S48, the process proceeds to operation S51 since there is a sink device PtoP-coupled to oPCR. The registered channel number is set in iPCR of the sink device, and “pcc” is updated in oPCR of the source device by using a lock transaction. An overlay PtoP connection illustrated in FIG. 4B is established. When the source device is not supported by the sink device in operation S45, the sink device may inquiry about another channel number.

When the channel number is not used in operation S42, for example, when there is no oPCR in which the channel number is set, a configuration ROM is read from the source device in operation S53. The process is terminated when it is determined based on the configuration ROM that the source device is not a corresponding audio-visual (AV) device (NO in operation S45). When it is determined based on the configuration ROM that the source device is a corresponding AV device (YES in operation S45), the bandwidth for IRM is obtained in operation S55, and the channel number is registered in operation S56.

The sink device searches for an unused output plug (oPCR) from among oPCR[n] of the source device. For example, the sink device obtains, from oPCR[0], the oPCR number of the source device and register values of oPCR based on a read request in operations S57 and S58. In operation S59, the sink device determines whether oPCR[0] is an unused oPCR, based on the register values of oPCR[0]. In operations S60 and S61, the sink device searches for an unused oPCR. When an unused oPCR is detected by the search (YES in operation S59), the process proceeds to operation S62. In operation S62, the format of the unused oPCR of the source device is set. In operation S63, the sink device sets the channel number in the unused oPCR and iPCR of the sink device using a lock transaction. A PtoP connection is established between oPCR of the source device and iPCR of the sink device, and oPCR of the source device may transfer Iso data to iPCR of the sink device.

In order to search for an unused oPCR, the sink device may issue a request packet to oPCR of the source device.

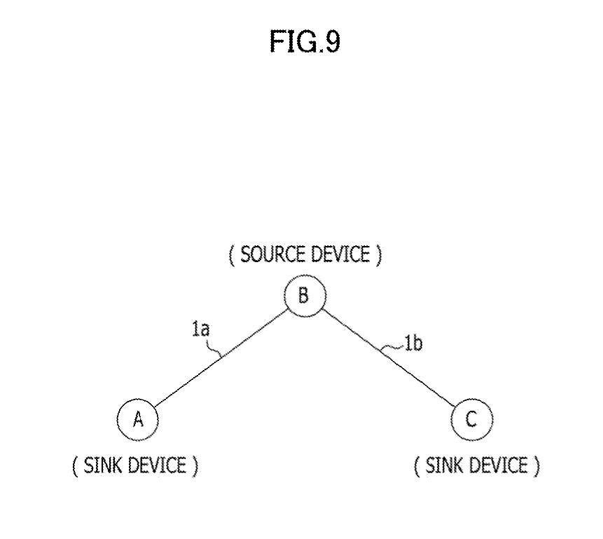

FIG. 9 illustrates an exemplary topology. Topology illustrated in FIG. 9, such as a system configuration, may be compliant with the IEEE 1394 standard. A node A is coupled via a bus cable 1a to a node B, and the node B is coupled via a bus cable 1b to a node C. The nodes A to C include, for example, a digital versatile disc (DVD) player, a digital television, or a digital settop box. For example, the nodes A and C may be sink devices, such as receivers, and the node B may be a source device, such as a transmitter.

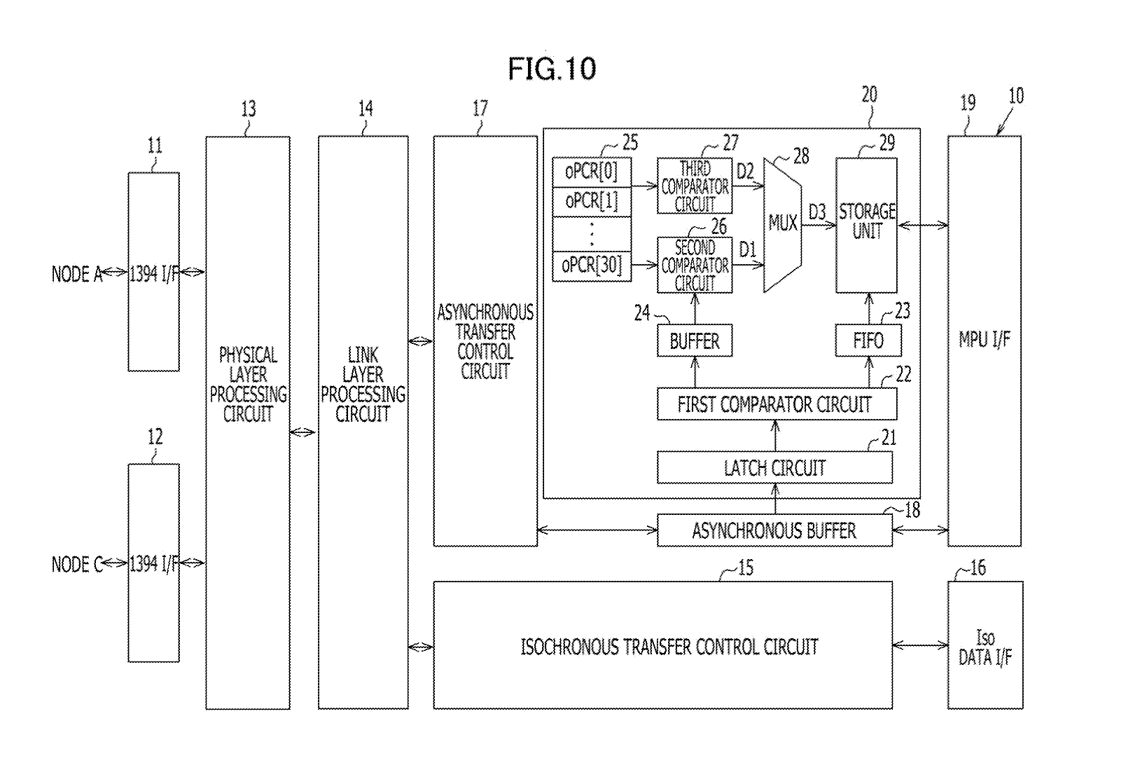

FIG. 10 illustrates an exemplary IEEE 1394 protocol controller. The nodes A to C may include IEEE 1394 protocol controllers (IPCs). For example, an IEEE 1394 protocol controller IPC 10 of the node B includes 1394 interfaces (I/Fs) 11 and 12, a physical layer processing circuit 13, a link layer processing circuit 14, an isochronous transfer control circuit 15, an isochronous data I/F 16, an asynchronous transfer control circuit 17, an asynchronous buffer 18, a microprocessing unit (MPU) I/F 19, and a connection control circuit 20.

The 1394 I/F 11 is coupled via the bus cable 1a to the node A. The 1394 I/F 12 is coupled via the bus cable 1b to the node C. The 1394 I/Fs 11 and 12 convert electrical signals received from other nodes into electrical signals for the interior of the device and output the electrical signals to the physical layer processing circuit 13. The 1394 I/Fs 11 and 12 convert electrical signals from the physical layer processing circuit 13 into electrical signals in the IEEE 1394 standard and send the electric signals to other nodes.

The physical layer processing circuit 13 monitors the status of a bus, performs initialization when a bus reset occurs, or performs speed signaling and arbitration. The physical layer processing circuit 13 converts electrical signals input from the 1394 I/Fs 11 and 12 into logic signals and outputs the logic signals to the link layer processing circuit 14. The physical layer processing circuit 13 converts logic signals input from the link layer processing circuit 14 into electrical signals and outputs the electrical signals to the 1394 I/Fs 11 and 12.

The link layer processing circuit 14 determines whether a packet is addressed to the link layer processing circuit 14, based on a logic signal input from the physical layer processing circuit 13, such as the header portion of packet data. When received packet data is addressed to the link layer processing circuit 14, the link layer processing circuit 14 determines whether the packet data is an isochronous (Iso) packet or an asynchronous (Asyn) packet, based on the header portion. When the received packet is an isochronous (Iso) packet, the link layer processing circuit 14 supplies the Iso packet to the Iso transfer control circuit 15. When the received packet is an asynchronous (Asyn) packet, the link layer processing circuit 14 supplies the Asyn packet to the Asyn transfer control circuit 17.

The link layer processing circuit 14 generates a standard packet compliant with the IEEE 1394 standard, based on data input from the Iso transfer control circuit 15 and the Asyn transfer control circuit 17, and outputs the standard packet to the physical layer processing circuit 13.

The Iso transfer control circuit 15 separates the header portion and the data portion of an Iso packet input from the link layer processing circuit 14, and performs error correction of the header portion and the data portion. The Iso transfer control circuit 15 supplies the error-corrected data to the Iso data I/F 16. The Iso transfer control circuit 15 generates an Iso packet format based on data input from the Iso data I/F 16, and supplies the Iso packet format to the link layer processing circuit 14.

The Asyn transfer control circuit 17 separates the header portion and the data portion of an Asyn packet input from the link layer processing circuit 14, and performs error correction of the header portion and the data portion. The Asyn transfer control circuit 17 supplies the error-corrected data to the Asyn buffer 18. The Asyn transfer control circuit 17 generates an Asyn packet based on data input from the Asyn buffer 18, and supplies the Asyn packet to the link layer processing circuit 14.

The Asyn buffer 18 outputs an Asyn packet input from the Asyn transfer control circuit 17 to the MPU I/F 19. The Asyn buffer 18 outputs data input from the MPU I/F 19 to the Asyn transfer control circuit 17. The MPU I/F 19 may interface an MPU (not illustrated) and the Asyn buffer 18.

The Asyn buffer 18 outputs an Asyn packet input from the Asyn transfer control circuit 17 to the connection control circuit 20. The connection control circuit 20 may generate a response format of a channel usage status command when the received Asyn packet includes a request format of the channel usage status command.

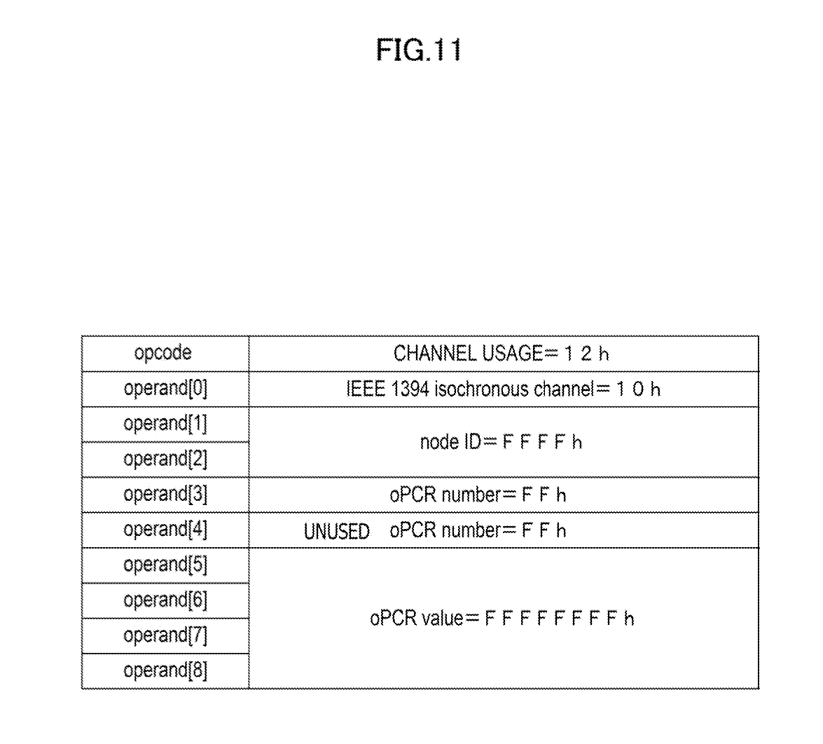

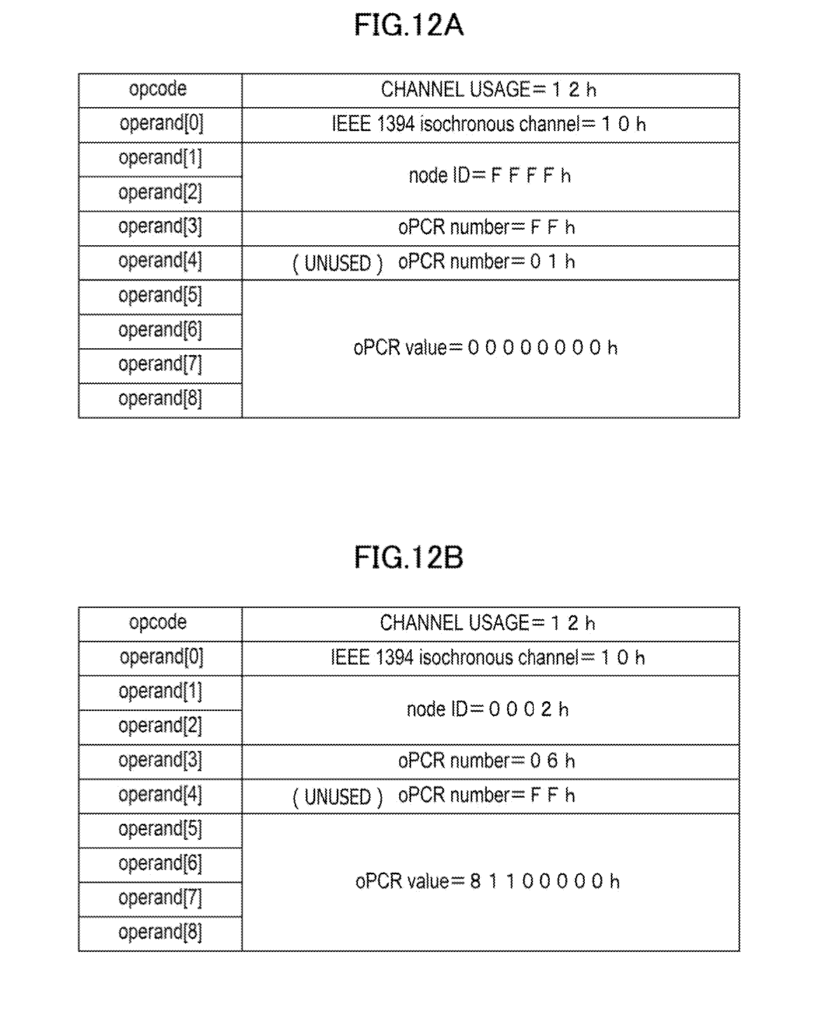

FIG. 11 illustrates an exemplary request format. FIGS. 12A and 12B illustrate exemplary response formats. The request format and the response formats illustrated in FIGS. 11, 12A, and 12B may each include a channel usage status command. [12h] is stored in opcode, and information for the command are stored in operands 0 to 8. A channel number is stored in operand 0, a node ID is stored in operands 1 and 2, an oPCR number is stored in operand 3, an unused oPCR number is stored in operand 4, and an oPCR value is stored in operands 5 to 8. For example, the request format and the response formats may each include operands 4 to 8.

In the request format illustrated in FIG. 11, [FFh] is stored in operand 4, and [FFFFFFFFh] is stored in operands 5 to 8. Operands 4 to 8 of the request format may be used to match with a response format. Operands 4 to 8 may be used to inquire the oPCR number or the oPCR value.

In the response formats illustrated in FIGS. 12A and 12B, information are stored in operands 4 to 8 based on oPCR in which the channel number is set. In a response format in which channel numbers is not set in all oPCR[n] of a source device, as illustrated in FIG. 12A, an unused oPCR number among oPCR[n], such as [01h], may be stored in operand 4. The value of the unused oPCR[1], such as a register value of the unused oPCR[1], may be stored in operands 5 to 8. The register value of the unused oPCR may be [00000000h]. The number and the register value of the unused oPCR may be included in information of an unused connection plug.

In a response format including oPCR in which the channel number is set, as illustrated in FIG. 12B, [FFh] is stored in operand 4. The value of oPCR in which the channel number is set, such as the register value [81100000h] of oPCR in which the channel number is set, is stored in operands 5 to 8. [FFh] stored in operand 4 may be greater than the upper limit of the oPCR number.

The connection control circuit 20 illustrated in FIG. 10 includes a latch circuit 21, a first comparator circuit 22, a First In First Out (FIFO) 23, a buffer 24, a register unit 25, a second comparator circuit 26, a third comparator circuit 27, a multiplexer 28, and a storage circuit 29.

The latch circuit 21 stores, based on an Asyn packet input from the Asyn buffer 18, the opcode in a request format, the channel number from a sink device, the node ID of a sending source, and the length of the request format.

The first comparator circuit 22 reads the opcode and the length of the request format from the latch circuit 21, and determines whether the opcode matches [12h]. The first comparator circuit 22 determines whether the length of the request format matches, for example, the length of the request format illustrated in FIG. 11. When they match, the first comparator circuit 22 stores the opcode, the channel number, the node ID of the sending source, and the length of the request format, which are read from the latch circuit 21, in the FIFO 23, and stores the channel number in the buffer 24. The FIFO 23 may process request packets transferred from a plurality of sink devices. The number of FIFOs arranged may be great. The data stored in the FIFO 23 may be cleared when a bus reset occurs.

The register unit 25 stores register values of oPCR[0] to oPCR[30] included in the node B. The second comparator circuit 26 compares the channel number included in the register values of oPCR with the channel number stored in the buffer 24, such as the channel number from a sink device. When the channel number included in the register values of oPCR matches the channel number stored in the buffer 24, a desired channel number may be set in oPCR. oPCR having the matched channel number may be oPCR in which the channel number is set. The second comparator circuit 26 outputs the number and register values of oPCR in which the channel number is set as a first output signal D1 to the multiplexer 28.

The third comparator circuit 27 compares initial values of oPCR with the register values of each oPCR. oPCR may be determined as an unused oPCR when the register values of oPCR match the initial values. The third comparator circuit 27 outputs the number and register values of the unused oPCR as a second output signal D2 to the multiplexer 28. The second and third comparator circuits 26 and 27 may perform comparisons in the ascending order of oPCR[n] number, for example.

The multiplexer 28 outputs one of the first and second output signals D1 and D2 from the second and third comparator circuits 26 and 27 respectively as a third output signal D3 to the storage unit 29. The multiplexer 28 outputs the first output signal D1, such as the number and register values of oPCR in which the channel number is set, to the storage unit 29 when the multiplexer 28 receives the first output signal D1 from the second comparator circuit 26. The multiplexer 28 outputs the second output signal D2 input from the third comparator circuit 27, such as the number and register values of the unused oPCR, to the storage unit 29 when the multiplexer 28 does not receive the first output signal D1 from the second comparator circuit 26.

The storage unit 29 stores the third output signal D3 input from the multiplexer 28, and data and a number obtaining flag input from the FIFO 23. The storage unit 29 stores, as a processing result, the channel number, the oPCR number of oPCR in which the channel number is set or the unused oPCR number, the register values of oPCR, the length of the request format, and the number obtaining flag. The number obtaining flag is set so that other sink devices may not use the unused oPCR device when the unused oPCR it set as the processing result. The third comparator circuit 27 determines whether oPCR[n] to be compared is an unused oPCR based on the number obtaining flag set in oPCR[n].

The storage unit 29 stores the processing result in a format in accordance with the length of the request format. In the processing result, the channel number, the oPCR number, and the register values of oPCR are formatted and stored, as in operands 0 to 8 of the response format illustrated in FIG. 12A, when the length of the request format matches, for example, the length of the format illustrated in FIG. 11. In the processing result, the channel number and the oPCR number are formatted and stored, as in operands 0 to 3 of the response format illustrated in FIG. 8B, when the length of the request format matches the length of the format illustrated in FIG. 8A. The storage unit 29 includes a storage capacity that stores processing results corresponding to a plurality of sink devices, such as 63 nodes. The storage unit 29 stores processing results in the order of, for example, the node number. Data stored in the storage unit 29 may be cleared when a bus reset occurs.

A write packet is generated when the processing result stored in the storage unit 29 is included in an FCP frame, and the write packet is returned to the sink device. The MPU, the MPU I/F 19, the Asyn buffer 18, the Asyn transfer control circuit 17, the link layer processing circuit 14, and the like generate a write packet based on the processing result read by the MPU I/F 19 from the storage unit 29. The storage unit 29, the MPU, the MPU I/F 19, the Asyn buffer 18, the Asyn transfer control circuit 17, and the link layer processing circuit 14 notify the sink device of the processing result.

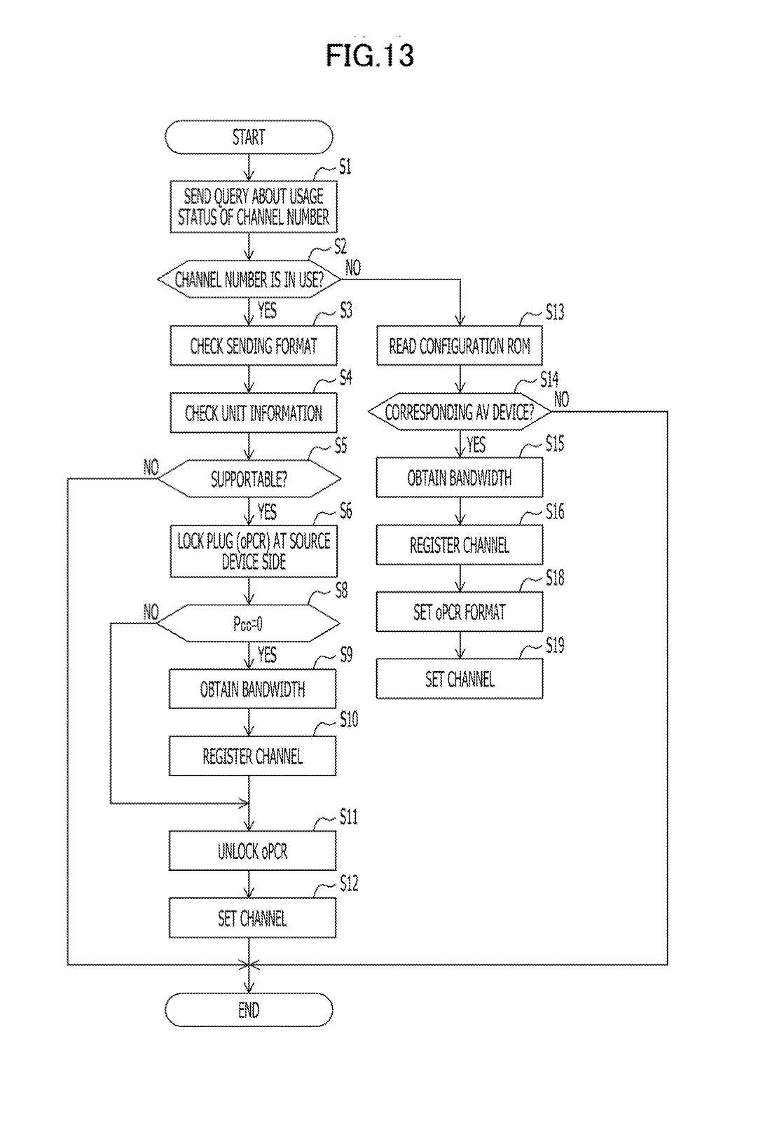

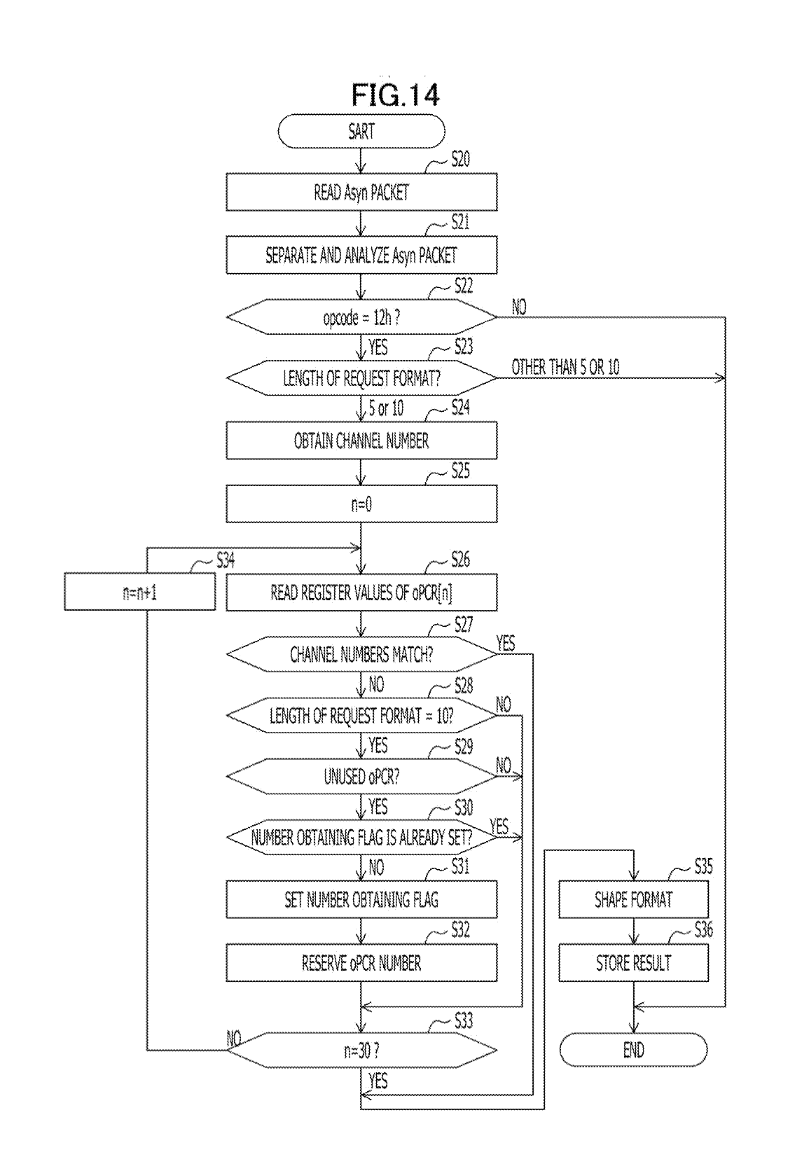

FIGS. 13 and 14 illustrate an exemplary establishment of a plug connection. For example, a bus reset occurs at a power-on. After the bus reset, in operation S1, the node A serving as a sink device queries all source devices, such as the node B, as to the usage status of a channel number [10h] that the node A wishes to couple to, by using a channel usage status command. The node A sends a write packet including data in the request format illustrated in FIG. 11 to the node B. The node B generates a write packet formed as a capsule including data in the response format illustrated in FIG. 12A or 12B, and sends the write packet to the node A.

When an Asyn packet such as a write packet from another node is input to the node B in operation S20, the link layer processing circuit 14 and the asynchronous transfer control circuit 17 separate and analyze the Asyn packet in operation S21. The analyzed Asyn packet is stored, via the Asyn buffer 18, in the latch circuit 21 in the connection control circuit 20. In operation S22, the first comparator circuit 22 determines whether the opcode of an AV/C command frame in the Asyn packet is [12h]. Since the write packet includes the request format of the channel usage status command, which is illustrated in FIG. 11, the opcode of the AV/C command frame may be [12h]. In operation S22, the received Asyn packet is determined to be a packet of the channel usage status command.

In operation S23, the first comparator circuit 22 determines whether the length of the request format of the channel usage status command is the length of the request format illustrated in FIG. 11, such as “10”, or the length of the request format illustrated in FIG. 8A, such as “5”. In operation S24, the channel number stored in operand 0 of the request format may be obtained. The channel number stored in operand 0 may be obtained when the length of the request format is “5”. The channel number stored in operand 0 is obtained when the received Asyn packet includes the request format illustrated in FIG. 11 or FIG. 8A. The process is terminated when the length of the request format is not “5” or “10” or when the opcode is not [12h].

A search is conducted to determine whether the set oPCR in which the channel number is set exists. In operations S25 and S26, the register values of oPCR[n], which are stored in the register unit 25, such as the register values of oPCR[0], are read. In operation S27, the second comparator circuit 26 compares the channel number included in the read register values of oPCR[n] with the obtained channel number. When the two channel numbers do not match (NO in operation S27) and when the length of the request format is “10” (YES in operation S28), a search for an unused oPCR may be conducted. For example, a search for an unused oPCR is conducted when the length of the request format is “10”.

In operation S29, the third comparator circuit 27 determines whether oPCR[n] is an unused oPCR by comparing the read register values of oPCR[n] with the initial values of oPCR. When it is determined that oPCR[n] is unused since the register values match the initial values (YES in operation S29), the third comparator circuit 27 determines whether the number obtaining flag is set in oPCR[n] in operation S30. When the number obtaining flag is not set in oPCR[n] (NO in operation S30), the number obtaining flag is set in operations S31 and S32, and the process proceeds to operation S33.

For example, when the length of the request format is “5” (NO in operation S28), the process proceeds to operation S33. A search for an unused oPCR may not be conducted. When oPCR[n] is not an unused oPCR (NO in operation S29), or when the number obtaining flag is set although oPCR[n] is an unused oPCR, the process proceeds to operation S33 since oPCR[n] is not be used.

The register values of oPCR[1] to oPCR[30] are obtained in the ascending order of the number until oPCR in which the channel number is set is detected or until an unused oPCR is detected in operations S33, S34, and S26. When oPCR in which the channel number is set, such as oPCR[6], is detected in operation S26, the process proceeds to operation S35. In operation S35, the length of the request format is determined. For example, when the length is “10”, the channel number, the node ID of its node, and the number and register values of oPCR in which the channel number is set are formatted, as in operands 0 to 8 of the response format illustrated in FIG. 12B. The setting of the number obtaining flag is reset before oPCR[6] in which the channel number is set is detected. For example, when the length of the request format is “5”, the channel number, the node ID of its node, and the oPCR number of oPCR in which the channel number is set are formatted, as in operands 0 to 3 of the response format illustrated in FIG. 8B.

When the channel number which is inquired is not set in all of oPCR[0] to oPCR[30] (YES in operation S33), oPCRs in which the number obtaining flag is set in operation S31, such as the first oPCR in which the number obtaining flag is set, may be set as an unused oPCR. In operation S35, the channel number, and the number and register values of the unused oPCR are formatted, as in operands 0 to 8 of the response format illustrated in FIG. 12A. The setting of the number obtaining flag in oPCR that is set as unused oPCR is reset. For example, since no search for an unused oPCR is conducted when the length of the request format is “5”, “FFFFFFh” is stored in operands 0 to 3 of the response format illustrated in FIG. 8B.

The formatted result is stored in the storage unit 29. In operation S36, the formatted result, such as a write packet including the response format, is generated. A write packet including the response format storing the number and register values of oPCR in which the channel number is set, which is illustrated in FIG. 12B, is generated when the set oPCR in which the channel number is set exists. A write packet including the response format storing the number and register values of the unused oPCR illustrated in FIG. 12A is generated when oPCR in which the channel number is set does not exist. For example, a write packet including the response format illustrated in FIG. 8B may be generated when the length of the requests format is “5”.

The node B sends the generated write packet to the node A. The node A determines whether the channel number is in use, based on the contents of the response format, when the node A receives the write packet including the response format in operation S2 illustrated in FIG. 13.

The channel number is in use when, for example, the response format illustrated in FIG. 12B is included in the write packet. Thus, the process proceeds to operation S3. The process in operations S3 to S6 illustrated in FIG. 13 may be substantially the same as or similar to the process in operations S43 to S46 illustrated in FIG. 5. For example, the register values of oPCR in which the channel number is set may be obtained by using a read request after operation S46 since a response format from a source device stores the oPCR number of oPCR in which the channel number is set. The response format illustrated in FIG. 12B stores the number and register values of oPCR in which the channel number is set. Therefore, operation S47 illustrated in FIG. 5, such as reading of the register values of oPCR in which the channel number is set by using a read request, may not be performed. In succession to operation S6, the node A performs operations S8 to S12 based on the number and register values of oPCR in which the channel number is set in the response format illustrated in FIG. 12B, thereby establishing a PtoP connection.

The channel number is unused (NO in operation S2) when the write packet from the node B includes the response format illustrated in FIG. 12A, and the process proceeds to operation S13. The process in operations S13 to S16 may be substantially the same as or similar to the process in operations S53 to S56 illustrated in FIG. 5. A sink device may read the register values of oPCR[n] of a source device by using a read request in order to search an unused oPCR. The response format illustrated in FIG. 12A includes the number and register values of an unused oPCR. Reading of the number and register values of oPCR by using a read request, such as operations S57 to S61 illustrated in FIG. 5, may not be performed. In succession to operation S16, the node A performs operations S18 and S19 based on the number and register values of the unused oPCR in the response format illustrated in FIG. 12A, thereby establishing a PtoP connection. The node ID of the node B may be obtained from “source_ID” in the write packet since the response format illustrated in FIG. 12A does not include the node ID of the node B, such as a source device.

In the node B, such as a source device, a search for an oPCR in which the channel number is set and a search for an unused oPCR, which are illustrated in FIG. 14, may be conducted by using the connection control circuit 20, i.e., hardware. Part or the entirety of the process illustrated in FIG. 14 may be executed using software.

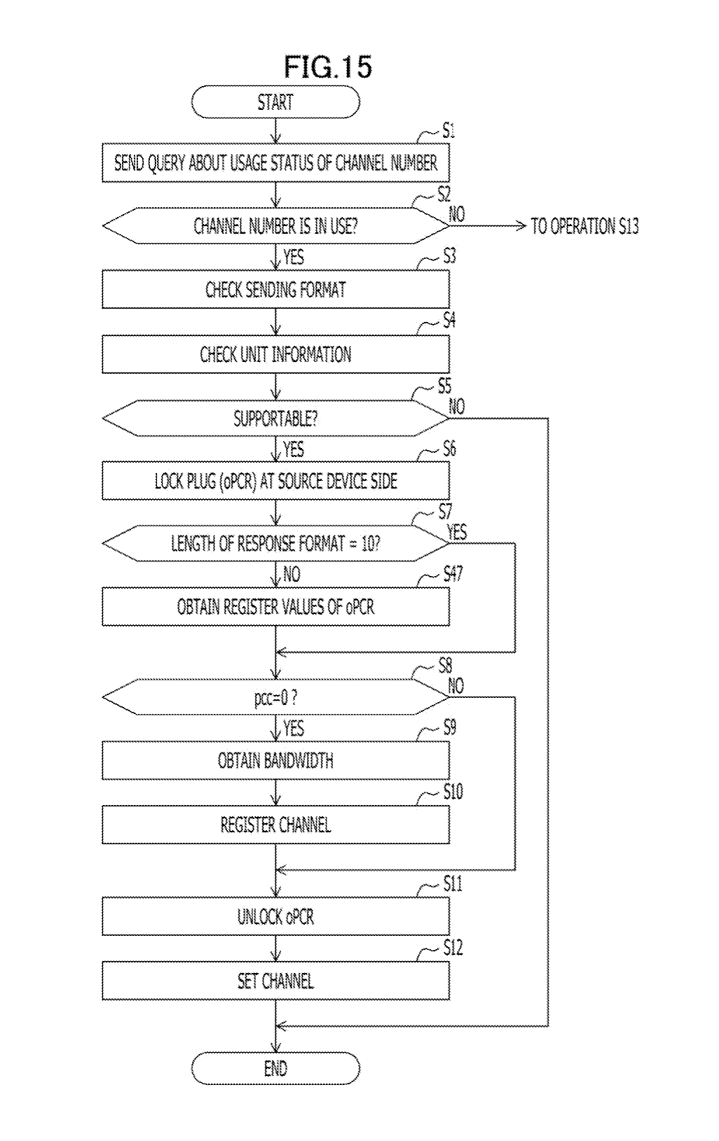

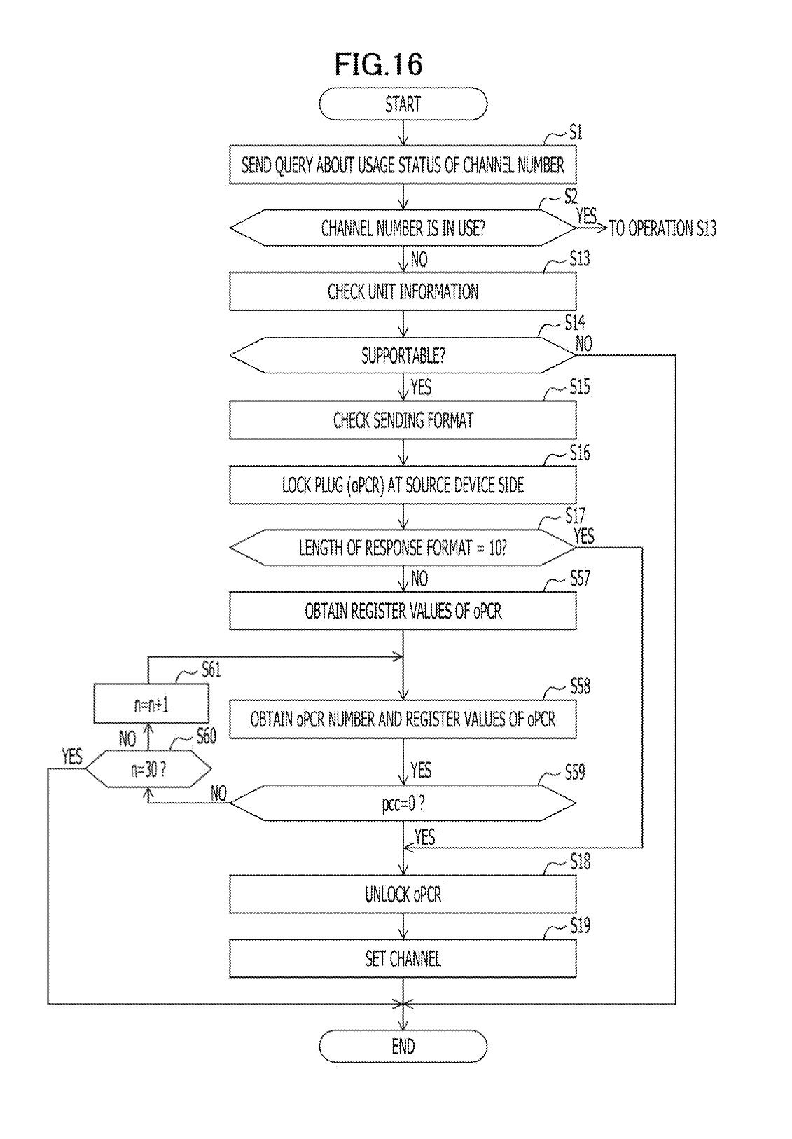

FIGS. 15 and 16 illustrate exemplary establishment of a plug connection. The process after it has been determined in operation S2 illustrated in FIG. 13 that the channel number is in use, such as operations S3 to S12, may be changed to the process illustrated in FIG. 15. A process of determining whether the length of the response format in the write packet received from the source device is “10”, such as operation S7, may be added after operation S6. The process may proceed to operation S8 when it is determined in operation S7 that the length of the response format is “10”, as illustrated in FIG. 15. When it is determined in operation S7 that the length of the response format is not “10”, such as when the length of the response format is “5”, the process may proceed to operation S8 after the register values of oPCR are obtained in operation S47 by using a read request. A plug connection is also established when the sink device receives the response format illustrated in FIG. 8A.

Operations S13 to S19 illustrated in FIG. 13 may be changed to the process illustrated in FIG. 16. For example, operation S17 illustrated in FIG. 16 may be added after operation S16. The process proceeds to operation S18 when the length of the response format is “10” in operation S17. When the length of the response format is not “10” in operation S17, such as when the length is “5”, a search for an unused oPCR is conducted by using a read request, and the process proceeds to operation S18. A plug connection is also established when the sink device receives the response format illustrated in FIG. 8B.

A write packet including the response format illustrated in FIG. 8B, instead of the response format illustrated in FIG. 8A, may be generated when oPCR in which the channel number is set exists. The response format illustrated in FIG. 12A may be generated when the channel number is unused. Advantages which are substantially the same as or similar to the embodiments described above may be achieved.

Operands 5 to 8 may be omitted from the response format illustrated in FIGS. 12A and 12B. Operand 4 in which the number of an unused oPCR is stored may be added to the formats illustrated in FIGS. 8A and 8B. The register values of an unused oPCR may be read by using a read request after operation S16 illustrated in FIG. 13. The number of request packets may decrease since numbers of oPCRs are obtained from response formats.

A search for an unused oPCR may be started after, for example, it is determined that there exists no oPCR in which the channel number is set by conducting a search for an oPCR in which the channel number is set.

Operation S28 illustrated in FIG. 14 may be skipped. Operations S30 to S32 illustrated in FIG. 14 may be skipped.

The number of nodes in a network is arbitrary. The previous embodiments are applicable to an apparatus compliant with the Intelligent Transport Systems (ITS) Data Bus (IDB)-1394 standard.

All examples and conditional language recited herein are intended for pedagogical objects to aid the reader in understanding the invention and the concepts contributed by the inventor to furthering the art, and are to be construed as being without limitation to such specifically recited examples and conditions. Although the embodiment(s) of the present inventions have been described in detail, it should be understood that the various changes, substitutions, and alterations could be made hereto without departing from the spirit and scope of the invention.

1. A data transfer method of transferring data between a source device and a sink device, comprising:
receiving a query about a channel number included in connection plug information sent from the sink device; and
notifying the sink device of information of an unused connection plug when a channel corresponding to the channel number is unused.

2. The data transfer method according to claim 1, wherein the information of the unused connection plug includes a number of a plug control register corresponding to the unused connection plug.

3. The data transfer method according to claim 2, wherein the information of the unused connection plug further includes a stored value of the plug control register corresponding to the unused connection plug.

4. The data transfer method according to claim 1, further comprising notifying a number and a stored value of a plug control register corresponding to a connection plug in which the channel number is set when the channel is in use.

5. The data transfer method according to claim 1, further comprising: searching for the unused connection plug by at least comparing a value of an output plug control register with an initial value.

6. The data transfer method according to claim 5, wherein the search is not conducted when receiving a query in a first request format, and
wherein the search is conducted when receiving a query in a second request format including certain information.

7. The data transfer method according to claim 5, further comprising checking whether a flag is set in information of a searched, unused connection plug.

8. The data transfer method according to claim 1, further comprising notifying the sink device of the information of the unused connection plug by a certain response format.

9. A data transfer apparatus that receives data transferred from a source device and that sends data to a sink device, comprising:
a plurality of connection plugs;
a search circuit that searches for an unused connection plug among the plurality of connection plugs; and
a notification circuit that notifies the sink device of information of the unused connection plug when a channel corresponding to a channel number sent from the sink device is unused.

10. The data transfer apparatus according to claim 9, wherein the information of the unused connection plug includes a number of a plug control register corresponding to the unused connection plug.

11. The data transfer apparatus according to claim 10, wherein the information of the unused connection plug further includes a stored value of the plug control register corresponding to the unused connection plug.

12. The data transfer apparatus according to claim 9, wherein the notification circuit notifies the sink device of a number and a stored value of a plug control register corresponding to a connection plug in which the channel number is set when the channel is used.

13. The data transfer apparatus according to claim 9, wherein the search circuit includes a first comparator circuit that compares a value of an output plug control register with an initial value.

14. The data transfer apparatus according to claim 9, further comprising a second comparator circuit that compares the channel number with a channel number stored in an output plug control register to check whether the channel is used.
